(19) United States
(12) Patent Application Publication
(10) Pub. No.: US 2013/0271284 A1
(43) Pub. Date: Oct. 17, 2013

(54) High Water Warning Device

(71) Applicant: Melvin Whitmire, Shepherd, TX (US)

(72) Inventor: Melvin Whitmire, Shepherd, TX (US)

(21) Appl. No.: 13/443,907

(22) Filed: Apr. 11, 2012

(51) Int. Cl. G08B 21/18

(52) U.S. Cl. CPC G08B 21/182
USPC 340/618

(57) ABSTRACT

A warning device to warn of a high water level may include a liquid level sensor to detect the high water level, a warning sign to provide a visible warning in response to the liquid level sensor detecting the high water level and a solar panel to power the liquid level sensor and the warning sign. The liquid level sensor may include a optical switch. The liquid level sensor may include a phototransistor. The liquid level sensor may include an LED light source. The solar panel may be connected to a battery.

### FIELD OF THE INVENTION

The present invention relates to warning devices and more particularly to a high water warning device.

### BACKGROUND

Anywhere it rains, it can flood. A flood is a general and temporary condition where properties are inundated by water or mudflow. Many conditions can result in a flood: hurricanes, overtopped levees, outdated or clogged drainage systems and rapid accumulation of rainfall.

Flood risk isn't just based on history, it's also based on a number of factors: rainfall, river-flow and tidal-surge data, topography, flood-control measures, and changes due to building and development.

During the spring, frozen land prevents melting snow or rainfall from seeping into the ground. Each cubic foot of compacted snow contains gallons of water and once the snow melts, it can result in the overflow of streams, rivers and lakes. Add spring storms to that and the result is often serious, spring flooding.

Long cold spells can cause the surface of rivers to freeze, leading to ice jams. When a rise in the water level or a thaw breaks the ice into large chunks, these chunks can become jammed at man-made and natural obstructions, resulting in severe flooding.

Flash floods are the #1 weather-related killer in the U.S. since they can roll boulders, tear out trees, and destroy buildings and bridges. A flash flood is a rapid flooding of low-lying areas in less than six hours, which is caused by intense rainfall from a thunderstorm or several thunderstorms. Flash floods can also occur from the collapse of a man-made structure or ice dam.

Water on roadways presents a potentially deadly hazard for motorists. In many circumstances, it is difficult to determine the depth of the water covering the roadway. The depth can vary from one or 2 inches to several feet. A depth of over 1 foot may cause the automobile or truck to lose mobility and may cause the vehicle to begin to sink or float away. Either situation may result in a significant danger to the occupants of the vehicle. Getting out of the vehicle may be difficult or impossible through the door and the window may provide the only access to the occupants of the vehicle.

In order to avoid these problems, a warning device is needed. However, the warning device may be required to be placed at a remote location where access to electric power may be limited. It would be desirable for a warning device to be self-sufficient and not require a external supply of electric power. Furthermore, it would be desirable for the warning device to use a minimal amount of electricity when the warning device is not activated in order to preserve power for when the warning device is activated due to a high level of water or other type of fluid.

### SUMMARY

A warning device to warn of a high water level may include a liquid level sensor to detect the high water level, a warning sign to provide a visible warning in response to the liquid level sensor detecting the high water level and a solar panel to power the liquid level sensor and the warning sign.

The liquid level sensor may include a optical switch.
The liquid level sensor may include a phototransistor.
The liquid level sensor may include an LED light source.
The solar panel may be connected to a battery.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a high water warning device of the present invention;

FIG. 2 illustrates an electrical diagram of the high water warning device of the present invention;

FIG. 3 illustrates another electrical diagram of the high water warning device of the present invention.

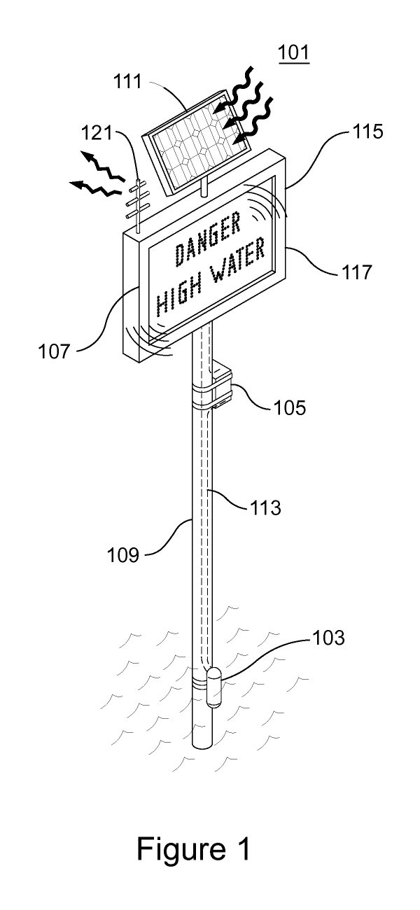

### DETAILED DESCRIPTION

Statistics show that many people die every year throughout the United States from driving in to high water. The warning device 101 of the present invention has the potential to help control insurance costs by preventing flooded vehicles and to save lives by warning the drivers and occupants of vehicles of the hazard of high water which may not be clearly visible.

The warning device 101 of the present invention is for detecting high water on roadways or other areas and activating a warning sign 107 to prevent vehicles from driving into it and either damaging property or losing lives, or both.

The warning device 101 of the present invention may be placed on roadways, under overpasses, on county or state roads near creek crossings, near bridges on interstates or anywhere there is a potential for high water.

The warning device 101 may include an liquid level sensor 103 which may include an optical switch or may include a water pressure sensor to detect the presence or absence of a fluid which may be water. The liquid level sensor 103 may be positioned at a predetermined height on a warning device poll 109. The predetermined height may be a height where water is at a potentially dangerous level. The liquid level sensor 103 may include an optical switch to detect the presence of water.

Optical switches incorporate a phototransistor that provides a digital output indicating the presence or absence of liquid. The sensor houses the phototransistor. A light may be used to reflect light through a channel which may or may not contain the liquid. When the liquid is present in channel, the refractive index from the light may be changed when covered by liquid, thus indicating the presence of the liquid. The photo transistor detects the change of refractive index and outputs a digital signal to indicate the change of reflective index and consequently the presence of the liquid in the channel. The output of the photo detector may be monitored by a microprocessor or central processing unit CPU which may in turn operate a signal to indicate the presence of the liquid in the channel.

The liquid level sensor 103 may be mounted on the bottom of the pole 109 and may be a “Photo Transistor Liquid Level Sensor” that detects the presence of high water.

The liquid level sensor 103 may be powered by a battery 105 which may be 12 volt DC battery, and the battery 105 may be charged with electric power by a solar panel 111 or other power generating device. The battery 105 may be 12 volt solar panel which may generate electricity from the solar rays of the sun. The battery 105 may be connected to the liquid level sensor 103 by wires 113, and the wires 113 may connect to the solar panel 111, may connect to the liquid level sensor 103 and may connect to the warning sign 107 to distribute power.

When the liquid level sensor 103 detects water, the liquid level sensor 103 transmits a signal which may be a voltage signal up through a relay 115, closing the contacts 117 to connect the battery 115 to activate the warning sign 107, which may be a 12 volt DC light emitting diode LED strobe light or other type of warning sign.

When the water recedes, the Light would be deactivated and go out. For the actual device, a metal pole would be used on which to mount the components. On the metal pole, there should be multiple sets of mounting holes on the bottom, so the sensor could be mounted at whatever height desired. One near optimal light for the device would be a blinking LED light powered by 12 volt DC battery, that may read “DANGER HIGH WATER”. A secondary warning sign could be placed on the roadway, prior to the light, saying “DANGER HIGH WATER WHEN FLASHING”

There could be many variations of the warning device 101, such as one in which the warning device 101 may remotely transmit a signal by the antenna to a remote electronic message sign which may receive multiple signals from multiple locations on the highway to warn of high water in a pre-defined remote area. It could also be used for many personal uses, such as detecting high water in basements, etc.

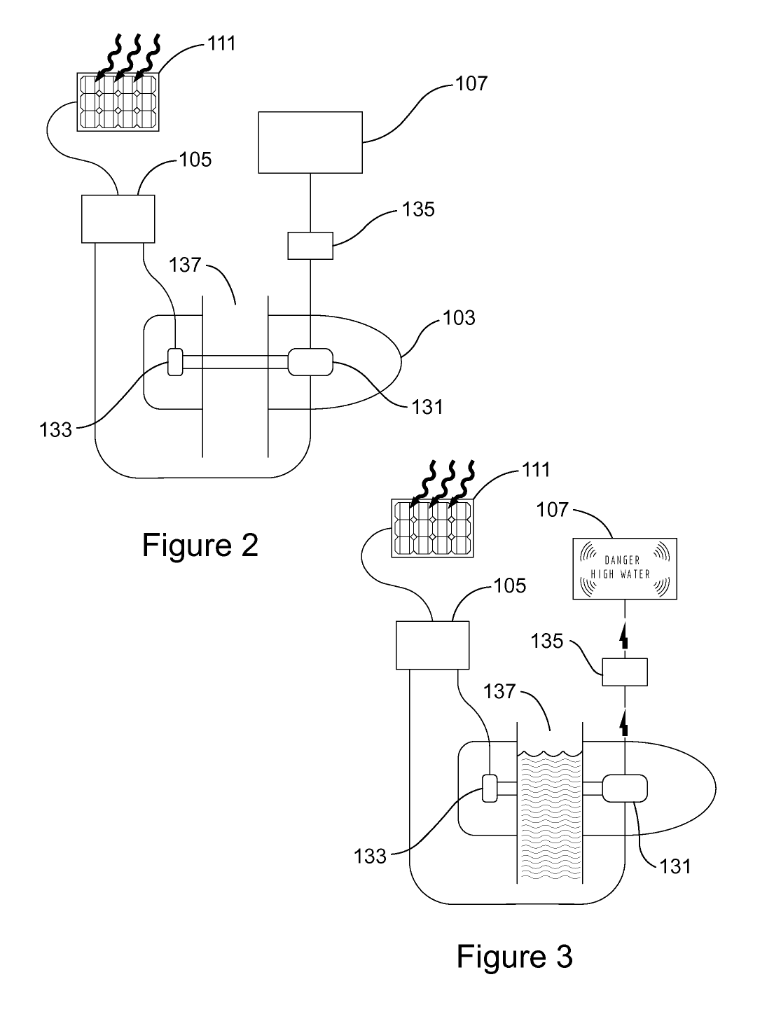

FIG. 2 illustrates a circuit diagram and illustrates the solar panel 111 being connected to the battery 105 which may be connected to the light source 133 and connected to the phototransistor 133 which may be connected to the controller 135 which may be a CPU or microcontroller. The controller 135 may be connected to the warning sign 107 and may activate the warning sign 107.

In operation, FIG. 2 illustrates no water in the channel 137. Light strikes the solar panel 111 which generates electrical power which is transmitted to the battery 105 where it is stored until required. Power from the battery is utilized by the light source 133 which may be an LED which generates light which is received by the phototransistor 131 and which generates a first signal which is transmitted to the controller 135. Since no water is detected, the warning sign 107 remain off.

In FIG. 3, the solar panel 111 and battery 105 operate in a similar fashion as described with respect to FIG. 2. However, water has entered the channel 137 which may partially or totally block the light from the light source 131. The phototransistor 131 transmits a second signal to the controller to indicate that water has entered the channel 137, and the controller 135 activates the warning sign 107 to warn of the high water danger.

The optical switch 103 may incorporate a phototransistor 131, a light source 133 which may be an LED to generate light rays that may extend across a channel 137 which may have access to the liquid for example water. The phototransistor 131 t provides a digital output signal indicating the presence or absence of the liquid based upon the light rays from the light source 133. The refractive index from the light source 133 is changed when covered by liquid in the channel 137 vs the refractive index when there is no liquid in the channel 137, thus indicating the level.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A warning device to warn of a high water level, comprising:
a liquid level sensor to detect the high water level:
a warning sign to provide a visible warning in response to the liquid level sensor detecting the high water level;
a solar panel to power the liquid level sensor and the warning sign.

2) A warning device to warn of a high water level as in claim 1, wherein the liquid level sensor includes a optical switch.

3) A warning device to warn of a high water level as in claim 1, wherein the liquid level sensor includes a phototransistor.

4) A warning device to warn of a high water level as in claim 1, wherein the liquid level sensor includes an LED light source.

5) A warning device to warn of a high water level as in claim 1, wherein the solar panel is connected to a battery.
